(19) United States
(12) Patent Application Publication
(10) Pub. No.: US 2010/0185739 A1
(43) Pub. Date: Jul. 22, 2010

(54) DIFFERENTIATED SPAM FILTERING FOR MULTIPLEXED MESSAGE RECEIVING DEVICES

(76) Inventor: Gary Stephen Shuster, Fresno, CA (US)

Correspondence Address: CONNOLLY BOVE LODGE & HUTZ LLP, P.O. BOX 2207, WILMINGTON, DE, 19899, US

(21) Appl. No.: 12/689,695

(22) Filed: Jan. 19, 2010

Related U.S. Application Data
(60) Provisional application No. 61/145,283, filed on Jan. 16, 2009.

(51) Int. Cl. G06F 15/16

(52) U.S. Cl. 709/206

(57) ABSTRACT

More than one message recipient devices are configured to receive electronic messages (e.g., e-mail) addressed to a single electronic address. The recipient devices may be multiplexed. Each device may use independently determined spam filtering parameters, and may therefore receive different mail sets. The filtering parameters may automatically adjust based on the monitored activities of the recipient devices. For example, the respective spam thresholds for the recipient devices may be switched based on the monitored activities of the recipient devices.

### CLAIM OF PRIORITY UNDER 35 U.S.C. §119

This patent application claims the benefit of U.S. Provisional Patent Application No. 61/145,283, filed Jan. 16, 2009, which is specifically incorporated by reference herein in its entirety.

### BACKGROUND OF THE INVENTION

1. Field of the Invention

The present invention is directed toward systems for differentiated spam filtering based on the monitored activities of electronic message recipient devices, and related methods.

2. Description of the Related Art

It is not uncommon for a user to have e-mails from a single e-mail account accessible from a number of different devices. For example, e-mails to abc@example.com may be accessible from a desktop computer and from various network-enabled mobile devices, such as, for example, a Blackberry®, iPhone®, or other mobile e-mail client. The e-mails may also pass through a spam filter prior to delivery so as to prevent the delivery of unwanted or unsolicited e-mails. A well-known problem associated with spam filters is that they are not always effective in selectively targeting and filtering out spam. Spam filters often suffer from being overinclusive in filtering out legitimate e-mails as spam (“false positives”) or underinclusive in allowing some spam to pass through. Additionally, spam filters apply to e-mails regardless of the time or location (i.e., desktop computer or mobile device) from which the e-mails are being accessed, or the activity levels of the e-mail receiving devices.

Because a user's tolerance for spam e-mails may differ depending on these circumstances, it would be desirable to provide differentiated spam filtering levels responsive to which device is currently in use, the location of the device, time of day, day of week, a time since mail on a recipient device was last accessed, or any user-determinable time period. It would also be desirable to adjust or switch spam filtering levels based at least in part on the monitored activity levels of the recipient devices.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, there is provided a method for differentiated spam filtering for multiple electronic message receiving devices. For example, the method may involve identifying a primary e-mail receiving device (e.g., desktop computer, laptop computer, tablet computer, or netbook) and a secondary e-mail receiving device (e.g., network-enabled mobile device), and applying a lower spam threshold to the primary device and a higher spam threshold to the secondary device.

The method may involve monitoring respective activities of the primary and secondary devices. In response to the primary device being inactive for greater than a defined period, the method may involve determining whether the secondary device has been active during the defined period. In response to the secondary device being active during the defined period, the method may involve adjusting filtering parameters of at least one of the lower and higher spam thresholds. The step of adjusting the filtering parameters may involve modifying a value stored on a computer memory, such as, for example, one or more of a trigger word or phrase in a given e-mail, day or time the given e-mail was sent or received, source or destination IP address of the given e-mail, or other parameter deemed useful for distinguishing less desirable or less important messages (e.g., spam) from more desirable or more important messages.

In accordance with one or more embodiments and corresponding disclosure thereof, there is provided an apparatus for differentiated spam filtering. For example, the apparatus may be configured as an e-mail server or as a processor or similar device. The apparatus may comprise an electrical component, such as, for example, a computer processor, for identifying a primary e-mail receiving device and a secondary e-mail receiving device, as well as an electrical component for applying a lower spam threshold to the primary device and a higher spam threshold to the secondary device. The apparatus may comprise an electrical component for monitoring respective activities of the primary and secondary devices.

The apparatus may also comprise an electrical component for determining whether the secondary device has been active during a defined period, in response to the primary device being inactive for greater than the defined period. In addition, the apparatus may comprise an electrical component for adjusting filtering parameters of at least one of the lower and higher spam thresholds, in response to the secondary device being active during the defined period.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 provides a block diagram of an exemplary system for differentiated spam filtering for multiplexed e-mail receiving devices.

FIG. 2 provides a flow chart for an exemplary method for providing differentiated spam filtering for multiplexed devices.

FIG. 3 provides a flow chart for another exemplary method for providing differentiated spam filtering for multiplexed devices.

FIG. 4A illustrates one embodiment of a method for differentiated spam filtering.

FIG. 4B shows further aspects of the method illustrated in FIG. 4A.

FIG. 5 illustrates one embodiment of an apparatus for differentiated spam filtering.

### DETAILED DESCRIPTION

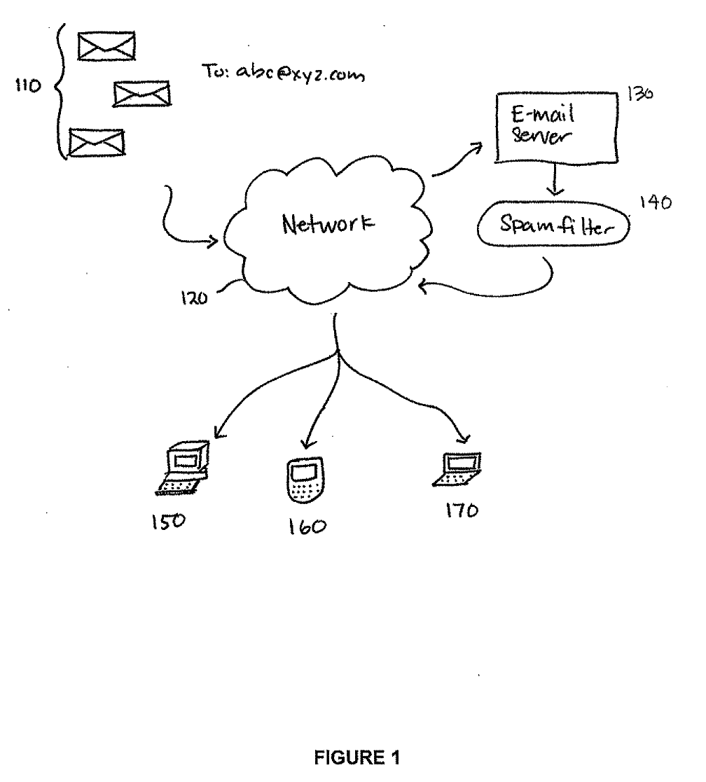

FIG. 1 is a block diagram showing an exemplary system for providing differentiated spam filtering for multiplexed electronic message (e.g., e-mail) receiving devices. In the system, e-mails 110 directed to a single e-mail account, e.g., abc@xyz.com, is sent through the network 120 and received by a receiving e-mail server 130.

A spam filter application 140 may process the e-mails 110 before they are delivered to the intended recipient. The spam filter application 140 may reside either directly on the e-mail server 130 or provided in a memory/processor associated with the e-mail server 130. While the spam filter application 140 is depicted in FIG. 1 as being associated with the e-mail server, spam filter application 140 may also be associated with each of the multiplexed e-mail receiving devices, either as separate programs, or as part of their e-mail program. In the alternative, a separate spam filtering agent application may reside at each device to receive user input, communicate with the server-level application 140, and/or measure device activity, and generally working in cooperation with the server-level spam filtering application.

After the e-mails 110 are processed by the spam filter application 140, they may be sent to a plurality of multiplexed e-mail receiving devices, such as a personal desktop computer 150, a network-enabled mobile telephone 160 and a Wi-Fi connected laptop computer 170. Typically, each of the multiplexed e-mail receiving devices receives the same set of e-mails that result from the spam filter application 140. However, the spam filter application 140 disclosed herein is configured to provide differentiated spam filtering levels based on when the e-mail 110 is received by the e-mail server 130, where the e-mail is delivered, or both.

Providing differentiated spam filtering levels for different e-mail receiving devices may be advantageous in allowing a user to avoid having to sift through significant spam from, for example, a mobile telephone. The disadvantage of having a higher spam threshold for the secondary device (i.e., a mobile telephone) is mitigated by the lower spam threshold provided by the primary receiving device (i.e., a desktop computer). Thus, legitimate e-mails that are filtered out as spam by the secondary device will likely pass the lower threshold set for the primary device. In addition, a user may want to set different spam filtering levels at different times. For example, the application may be configured to impose more stringent filtering screens at user designated times, such as when the user is likely to be at work or in a meeting, and less stringent filtering screens at other times, such as after work.

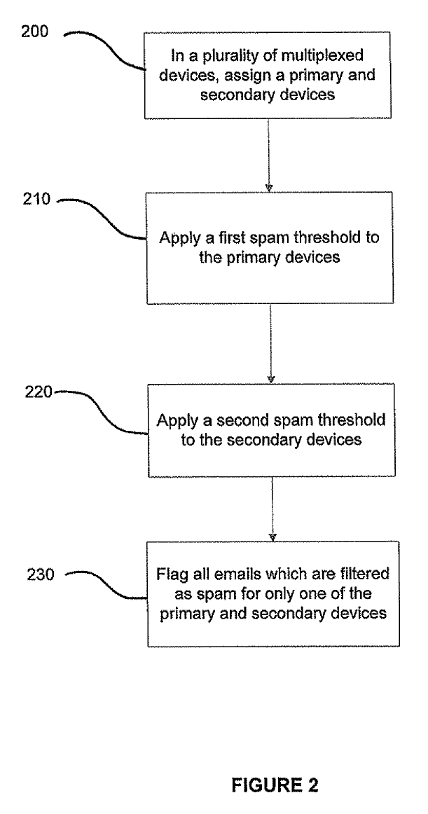

FIG. 2 is a flow chart showing exemplary steps of a method for providing differentiated spam filtering for multiplexed devices. In step 200, the user selects primary and secondary devices among a plurality of multiplexed e-mail receiving devices. For example, the primary device may be a desktop computer and the secondary device may a network-enabled mobile telephone. In step 210, a first spam threshold is applied to the primary device(s). The first spam threshold may be set at a lower threshold such that it may tend to be underinclusive. In steps 220, a second spam threshold is applied to the secondary device(s). In contrast to the first spam threshold, the second spam threshold may be set at a higher threshold such that it may tend to be overinclusive. While FIG. 2 illustrates an example of a primary and secondary device, it is understood that additional devices may be provided. Likewise, the method is not limited to one having only two spam thresholds, but may have a plurality of different spam thresholds having various different spam filtering levels based on any number of criteria known in the art.

In step 230, all e-mails which are filtered as spam from the secondary device may be flagged in the primary device. Thus, when a user returns to the primary device, he/she will be able to ascertain which ones of the e-mails were filtered out as spam by the second spam threshold and thus not delivered to the secondary device.

The first and second spam thresholds may be assigned to the primary and secondary devices based on time of day, day of the week, etc. Under prior art, there is no differentiation in spam filtering levels, so a user who is unable to set spam filtering sufficiently aggressively to avoid significant spam without screening out desired messages may thus during the day may receive an undesirably large number spam messages on the Blackberry® or other mobile e-mail client. For example, a user at Pfizer® who markets Viagra® would by definition may unable to filter aggressively without filtering out many legitimate e-mails about Viagra, but may set more aggressive screens at critical times. An example of a more stringent or aggressive screening algorithm is one in which all messages are screened out except those that originate from one or more predesignated sources.

In accordance with one embodiment, the user may schedule when the mobile receiving device, such as a Blackberry®, is the only device regularly checked and when both the desktop computer and the mobile devices are regularly checked. In accordance with this embodiment, for example, the mobile device may aggressively filter and deliver only messages that are clearly not spam during business hours (i.e., Monday through Friday between 8:00 am. and 6:00 p.m.). The desktop computer, by contrast, may have a lower spam threshold and thus receive e-mails that have higher levels of spam but fewer false positives. A lower spam threshold may be programmed to apply to the mobile device outside of business hours and on weekends to avoid delays in delivery of e-mail such that the mobile device may receive e-mails which, under a more aggressive filtering level, would be filtered out as false positives. The application of the differentiated spam filter levels may be algorithmic, user-programmable, or both.

Spam filtering thresholds are may also be varied based on time of day, day of week, vacation or non-vacation day status, or delivery location. In a preferred embodiment, the primary device may have a lower tolerance for false positives. Accordingly, during business hours, Monday through Friday, a user who has e-mail simultaneously delivered to desktop computer and a mobile device may elect a system whereby mail is delivered to the mobile device only where the chance of spam is exceedingly low, and thus the risk of filtering out false positives rather high. Simultaneously, the mail trapped as spam to the mobile device is delivered to the desktop (and optionally marked as not delivered to the mobile device). Thus, when the user check e-mails at the desktop computer before leaving for the day, avoiding being interrupted during meetings and the like by blackberry spam, but also avoiding not getting mail trapped by the blackberry-level filter as spam (but in fact not spam).

Differential spam filtering between devices that otherwise would have simultaneous delivery of certain categories of e-mail is a significant and valuable advance in the art. This, combined with programmatic changes to the relative filtering levels based on user input, time of day, day of month, holiday or non-holiday status, day of week, and/or work status and time left in the workday, balances the need to filter spam e-mail while at the same time ensuring that legitimate e-mails do not get discarded as spam.

In accordance with an alternative enhancement, the filtering levels between the primary and secondary devices may be changed or switched if e-mail from the primary device has not been checked or if the device(s) have been inactive for greater than a predetermined time period. Additionally, previously filtered e-mails for a secondary mobile device received in between the time the desktop device was last checked and the present or some other period (i.e. an hour before the present) may be retroactively re-evaluated and sent with a lowered spam filtering threshold. Delivery need not be simultaneous but may be made first to the device most recently checked. In addition, the primary and secondary device status may be flipped depending on which device was last checked or interacted with.

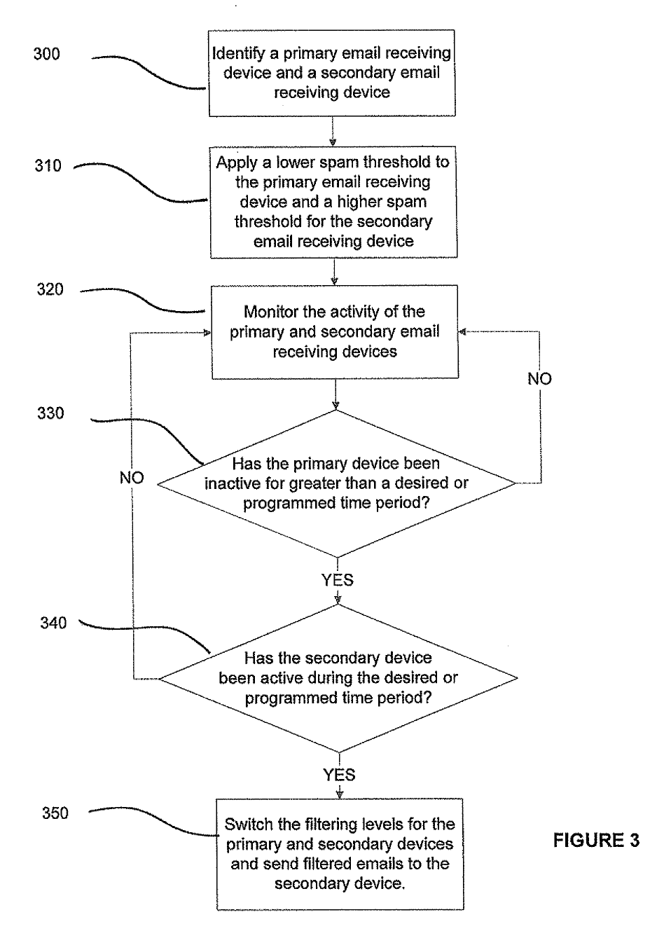

FIG. 3 is a flow chart showing exemplary steps of another method for providing differentiated spam filtering for multiplexed devices. In step 300, primary and secondary e-mail receiving devices are identified. The primary e-mail receiving device may be a desktop computer or other device which serves as the base and the secondary e-mail receiving device may be a network-enabled mobile device. Alternatively, both primary and secondary receiving devices may be network-enabled mobile devices. As can be appreciated, any kind and number of devices may be identified as the primary and secondary devices and is not limited by the examples provided herein.

In step 310, a lower spam threshold may be applied to the primary e-mail receiving device and a higher spam threshold may be applied to the secondary e-mail receiving device. In step 320, the activity of the primary and secondary e-mail receiving devices may be monitored. In step 330, it is determined whether the primary device has been inactive for a greater than a desired or programmed time period. If the primary device has not remained active within the time period, then, at step 340, it is determined whether the secondary device has been active during the same time period. If the secondary device is determined to be active, then the filtering levels for the primary and secondary devices are switched, such that the secondary device is assigned the lower spam threshold level. Optionally, e-mails that were sent during the time period and filtered from the secondary device under the higher threshold, but sent to the primary device, may be sent to the secondary device. Again, this feature avoids delay in the delivery of e-mail to the user when the primary device is not checked for an extended period of time.

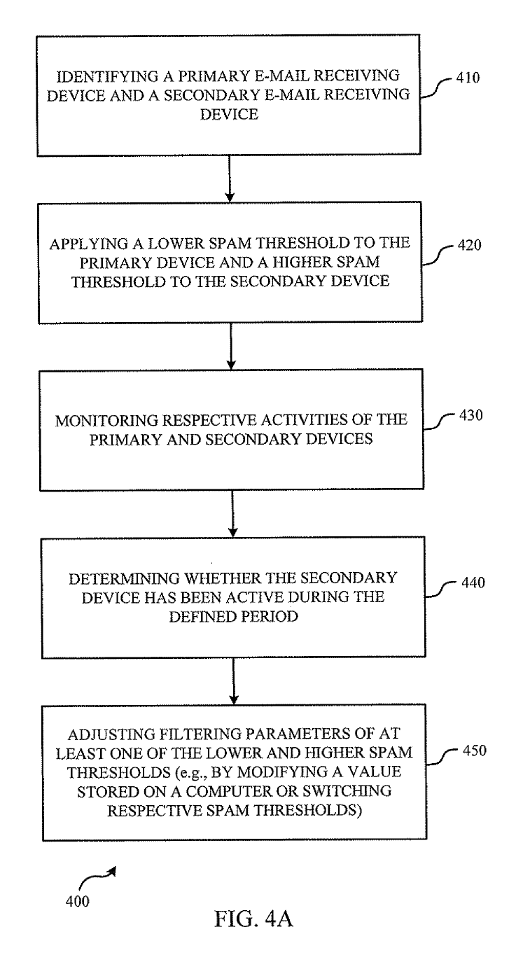

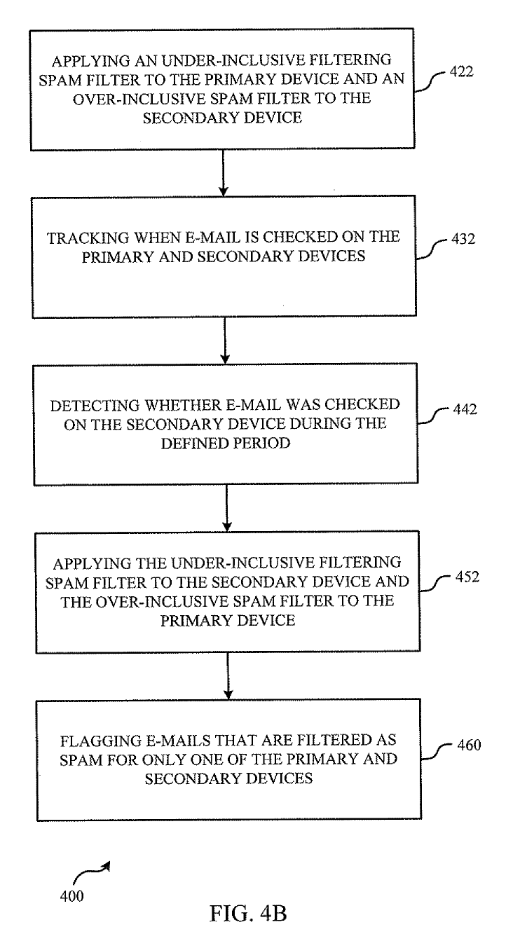

In accordance with one or more aspects of the embodiments described herein, there are provided methods for differentiated spam filtering for a plurality of computing or communication devices (e.g., multiplexed e-mail receiving devices). With reference to FIG. 4A, there is provided an exemplary method 400 that may involve identifying a primary e-mail receiving device and a secondary e-mail receiving device (step 410), and applying a lower spam threshold to the primary device and a higher spam threshold to the secondary device (step 420). For example, the primary device may comprise a desktop computer, a laptop computer, a tablet computer, or a netbook. In the alternative, or in addition, the secondary device may comprise a network-enabled mobile device or the like.

The method 400 may involve, at step 430, monitoring respective activities of the primary and secondary devices. In response to the primary device being inactive for greater than a defined period (e.g., a desired or programmed time period), the method 400 may involve determining whether the secondary device has been active during the defined period (step 440). In response to the secondary device being active during the defined period, the method 400 may involve adjusting filtering parameters of at least one of the lower and higher spam thresholds (step 450).

It is noted that step 450 may involve modifying a parameter value stored on a computer memory deemed useful for assigning incoming messages to a defined quality class, for example, “spam,” “personal,” “job-related,” or any other classification. The parameter value may comprise any useful variable or data used in a classifying algorithm. For example, a parameter may comprise or identify a key word, list of key words and variations, or data patterns used in one or more algorithms that classify messages according to the presence, absence, distribution, or recurrence of particular words, phrases, sentences, names, numbers, time indicators, true/false indicator or identifiable data patterns present in one or more data fields of each message. Message data fields that may be analyzed using a classification algorithm that is adjustable by setting classification parameter values may include, but are not limited to, sender address, originating mail server, day or time the message is sent or received, source or destination IP address of the given e-mail, addressee values, and message body. Classification parameter values stored on a computer may include, for example, text, numbers, and/or symbols and may relate to one or more of keywords (e.g., Viagra), word or phrase triggers, combinations of words, IP addresses, source port, destination port, communication protocol, and other data. Such filtering parameters and stored/modified values may relate to DomainKeys, sender policy frameworks, challenge/response systems, checksums, Domain Name System (DNS) blacklists and whitelists, greylists, verifying compliance with standard addressing and mail transfer agent (MTA) operation, Honeypots, reverse DNS lookup, Simple Mail Transfer Protocol (SMTP) callback verification, port blocking, or other data.

In related aspects, as shown in FIG. 4B, step 420 may comprise applying an under-inclusive filtering spam filter to the primary device and an over-inclusive spam filter to the secondary device (step 422). Step 450 may comprise applying the under-inclusive filtering spam filter to the secondary device and the over-inclusive spam filter to the primary device (step 452). As used herein, “under-inclusive” and “over-inclusive” refer to the relative propensity of a message classification process (for example, a spam filter) to include messages within a defined classification result. The terms are not used to signify any absolute level of inclusivity and do not connote that inclusivity is any more or less than desired under the circumstances. For example, a spam filter adjusted to be “over-inclusive” identifies a smaller percentage of incoming messages as spam, relative to the same filter when adjusted to be “under-inclusive.”

In further related aspects, step 430 may comprise tracking when e-mail is checked on the primary and secondary devices (step 432). Likewise, step 440 may comprise detecting whether e-mail was checked on the secondary device during the defined period (step 442). In other related aspects, the method 400 may further involve flagging e-mails that are filtered as spam for only one of the primary and secondary devices (step 460).

It is noted that one or more of the steps of method 400 may be performed on an e-mail server, a memory/processor associated with the e-mail server, or a computing device in operative communication with the e-mail server. It is further noted that the steps of method 400 may be performed in a distributed manner by a plurality of computers in operative communication with each other via one or more interlinked networks. It is also noted that one or more of the steps of method 400 may be performed by at least one e-mail receiving device or component thereof.

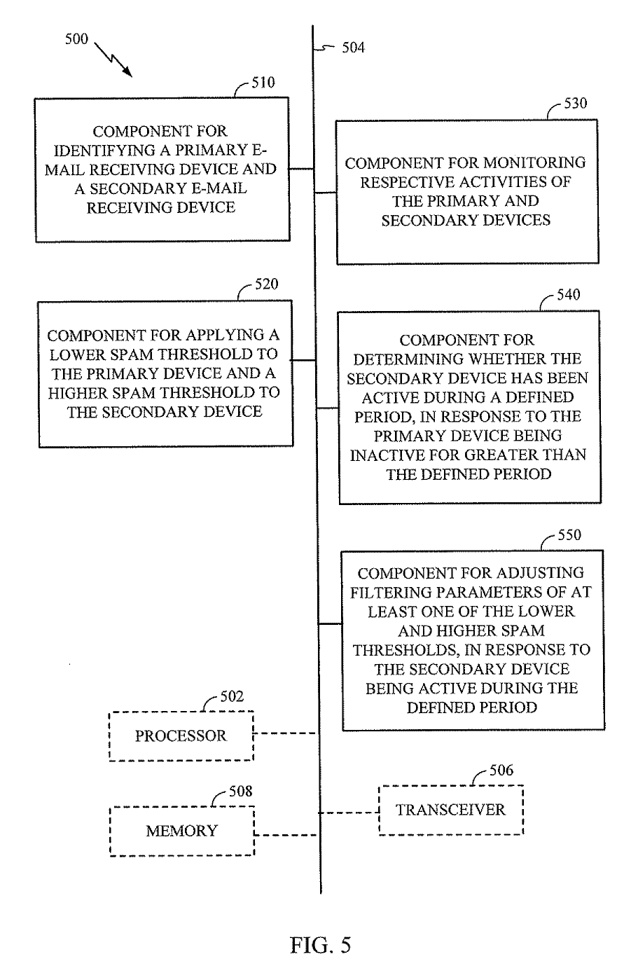

In accordance with one or more aspects of the embodiments described herein, there are provided devices and apparatuses for differentiated spam filtering. With reference to FIG. 5, there is provided an exemplary apparatus 500 that may be configured as an e-mail server or as a processor or similar device. As depicted, apparatus 500 may include functional blocks that can represent functions implemented by a processor, software, or combination thereof (e.g., firmware).

As illustrated, apparatus 500 may comprise an electrical component 510 for identifying a primary e-mail receiving device and a secondary e-mail receiving device, as well as an electrical component 520 for applying a lower spam threshold to the primary device and a higher spam threshold to the secondary device. Apparatus 500 may comprise an electrical component 530 for monitoring respective activities of the primary and secondary devices.

Apparatus 500 may also comprise an electrical component 540 for determining whether the secondary device has been active during a defined period, in response to the primary device being inactive for greater than the defined period. In addition, apparatus 500 may comprise an electrical component 550 for adjusting filtering parameters of at least one of the lower and higher spam thresholds (e.g., switching respective spam thresholds for the primary and secondary devices), in response to the secondary device being active during the defined period. For example, component 550 may comprise a subcomponent for modifying a value stored on a computer memory, wherein the value relates to one or more of (a) a trigger word or phrase in a given e-mail, (b) day or time the given e-mail was sent or received, (c) source or destination IP address of the given e-mail. In the alternative, or in addition, component 550 may comprise a subcomponent for switching respective spam thresholds for the primary and secondary devices.

It is noted that apparatus 500 may optionally include a processor module 502 having at least one processor, in the case of apparatus 500 configured as a communication network entity, rather than as a processor. Processor 502, in such case, may be in operative communication with electrical components 510-550 via a bus 504 or similar communication coupling. Processor 502 may effect initiation and scheduling of the processes or functions performed by electrical components 510-550.

In related aspects, apparatus 500 may include a transceiver module 506. A stand alone receiver and/or stand alone transmitter may be used in lieu of or in conjunction with transceiver 506. In further related aspects, apparatus 500 may optionally include a module for storing information, such as, for example, a memory device/module 508. Computer readable medium or memory device/module 508 may be operatively coupled to the other components of apparatus 500 via bus 504 or the like. The computer readable medium or memory device 508 may be adapted to store computer readable instructions and data for effecting the processes and behavior of electrical components 510-550, and subcomponents thereof, or processor 502, or the methods disclosed herein. Memory module 508 may retain instructions for executing functions associated with electrical components 510-550. While shown as being external to memory 508, it is to be understood that one or more of electrical components 510-550 may exist within memory 508.

Having thus described embodiments of method and system for differentiated spam filtering for multiplexed e-mail receiving devices, it should be apparent to those skilled in the art that certain advantages of the within system have been achieved. It should also be appreciated that various modifications, adaptations, and alternative embodiments thereof may be made within the scope and spirit of the present invention.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

What is claimed is:

1. A method for differentiated message filtering, comprising:
on a computer, identifying a primary electronic message receiving device and a secondary electronic message receiving device both eligible to receive electronic messages addressed to a unitary address;
filtering the electronic messages using different first and second filtering processes, the first filtering process identifying first messages of the electronic messages for access using the primary receiving device, and the second filtering process identifying second messages of the electronic messages for access using the secondary receiving device, wherein the first and second messages comprise different message sets;
monitoring respective activities of the primary and secondary devices to determine respective activity levels of the primary and secondary devices; and
in response to the respective activity levels, adjusting a filtering parameter used by at least one of the first and second filtering processes.

2. The method of claim 1, wherein adjusting the filtering parameter comprises modifying at least one value stored on a computer memory operative to change operation of at least one of the first and second filtering processes.

3. The method of claim 1, wherein filtering the electronic messages comprises applying an under-inclusive spam filter for the primary device and an over-inclusive spam filter for the secondary device.

4. The method of claim 3, wherein adjusting the filtering parameter comprises exchanging respective spam filters used for the primary and secondary devices, thereby applying the under-inclusive filtering spam filter to the secondary device and the over-inclusive spam filter to the primary device.

5. The method of claim 1, wherein monitoring respective activities comprises tracking message access activity at the primary and secondary devices.

6. The method of claim 1, wherein monitoring respective activities comprises determining activity levels selected from the group consisting of active and inactive.

7. The method of claim 1, wherein filtering the electronic messages comprises preventing at least one of the first messages from being included in the second messages.

8. The method of claim 1, wherein the primary and secondary devices comprise respective multiplexed e-mail receiving devices.

9. The method of claim 8, wherein the primary device comprises one of a desktop computer, a laptop computer, a tablet computer, and a netbook.

10. The method of claim 9, wherein the secondary device comprises a network-enabled mobile device.

11. An server for differentiated spam filtering, comprising:
a transceiver module for receiving information regarding a primary e-mail receiving device and a secondary e-mail receiving device;
at least one processor operatively coupled with the transceiver module; and
a memory module operatively coupled with the at least one processor and comprising executable code for the at least one processor to:
apply a lower spam threshold to the primary device and a higher spam threshold to the secondary device;
monitor respective activities of the primary and secondary devices;
in response to the primary device being inactive for greater than a defined period, determine whether the secondary device has been active during the defined period; and
in response to the secondary device being active during the defined period, adjust filtering parameters of at least one of the lower and higher spam thresholds.

12. The server of claim 11, wherein the at least one processor adjusts the filtering parameters by modifying a value stored on a computer memory to thereby modify operation of at least one of the higher and lower spam thresholds.

13. The server of claim 11, wherein the at least one processor applies an under-inclusive filtering spam filter to the primary device and an over-inclusive spam filter to the secondary device.

14. The server of claim 13, wherein the at least one processor adjusts the filtering parameters by switching respective spam thresholds for the primary and secondary devices.

15. The server of claim 14, wherein the at least one processor switches the respective spam thresholds by applying the under-inclusive filtering spam filter to the secondary device and the over-inclusive spam filter to the primary device.

16. The server of claim 11, wherein the at least one processor monitors the respective activities by tracking when e-mail is checked on the primary and secondary devices.

17. The server of claim 11, wherein the at least one processor determines whether the secondary device has been active by detecting whether e-mail was checked on the secondary device during the defined period.

18. A computer program product, comprising:
a storage medium comprising:
code for causing a computer to identify a primary e-mail receiving device and a secondary e-mail receiving device;
code for causing a computer to apply a lower spam threshold to the primary device and a higher spam threshold to the secondary device;
code for causing a computer to monitor respective activities of the primary and secondary devices;
code for causing a computer to determine whether the secondary device has been active during a defined period, in response to the primary device being inactive for greater than the defined period; and
code for causing a computer to adjust filtering parameters of at least one of the lower and higher spam thresholds, in response to the secondary device being active during the defined period.

19. The computer program product of claim 18, wherein the storage medium further comprises code for causing a computer to monitor the respective activities by tracking access of e-mail using the primary and secondary devices.

20. The computer program product of claim 18, wherein the storage medium further comprises code for causing a computer to determine whether the secondary device has been active by detecting whether e-mail was checked on the secondary device during the defined period.
